(19) United States
(12) Patent Application Publication
(10) Pub. No.: US 2005/0270009 A1
(43) Pub. Date: Dec. 8, 2005

(54) Display device

(76) Inventors: Youichi Ohki, Mobara (JP); Youzou Nakayasu, Mobara (JP); Yuichi Numata, Mobara (JP); Mitsuru Goto, Chiba (JP); Yoshinori Aoki, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/147,254

(22) Filed: Jun. 8, 2005

(30) Foreign Application Priority Data
Jun. 8, 2004 (JP) 2004-169393

(51) Int. Cl. G02F 1/1347; G05F 1/66

(52) U.S. Cl. 323/298; 323/311

(57) ABSTRACT

In a liquid crystal display module which includes a first display panel and a second display panel, it is possible to reduce a voltage drop attributed to the line resistance of a drive voltage supplied to the second display panel without increasing the cost. For this purpose, the first display panel includes a power source circuit which generates a drive voltage, the second display panel includes a scanning line drive circuit which drives scanning lines of the second display panel, a power source line of the first display panel, a power source line to which the drive voltage generated by the power source circuit is supplied and a variable resistance circuit which is connected with the power source line. The scanning line drive circuit drives the scanning lines of the second display panel in response to a drive voltage outputted from the variable resistance circuit.

### BACKGROUND OF THE INVENTION

The present invention relates in general to a display device which includes two display panels, and, more particularly, the invention relates to a display device which is mounted on portable equipment, such as a mobile phone or the like.

ATFT (Thin Film Transistor) liquid crystal display module having a miniaturized liquid crystal display panel with the number of sub pixels being approximately 120×160×3 in a color display, or an EL display device having an organic EL element, has been popularly used as a display part of portable equipment, such as a mobile phone. Further, a foldable mobile phone, which includes a main display part and a sub display part, also has been available recently.

As an example of a liquid crystal display module for a mobile phone having a main display part and a sub display part, there is a known integral-type liquid crystal display module which includes a first liquid crystal display panel corresponding to the main display part and a second liquid crystal display panel corresponding to the sub display part.

Inventors of the present invention have filed a patent application for an invention related to such an integral-type liquid crystal display module, which is characterized in that a source driver and a power source circuit for driving the second liquid crystal display panel include a drive IC, which is arranged on a first liquid crystal display panel side in common, and a gate driver is provided, which is dedicated to the second liquid crystal display panel (see Japanese Patent Application 2003-317978, hereinafter referred to as “patent literature”).

In the integral-type liquid crystal display module described in the above-mentioned patent literature, a gate-non-selection first drive voltage (VGL) (a voltage which turns off a gate of a thin film transistor) and a gate-selection second drive voltage (VGH) (a voltage which turns on the gate of the thin film transistor), which has a higher potential than the first drive voltage (VGL), both of which are output by the gate driver to scanning lines of the second liquid crystal display panel, are supplied from a power source circuit mounted on the first liquid crystal display panel.

These drive voltages are supplied to the second liquid crystal display panel through a power source line on the first liquid crystal display panel and a connection line of a flexible printed circuit board which connects the first liquid crystal display panel and the second liquid crystal display panel, and, hence, these drive voltages are subject to influence by the wiring resistance.

For example, when all scanning lines on the second liquid crystal display panel are driven or the like, the electric current which flows in the lines becomes large, and, hence, due to a voltage drop attributed to the wiring resistance, the voltage value of the drive voltage supplied to the second liquid crystal display panel tends to fluctuate.

Accordingly, there has been a drawback in that a thin film transistor located inside of the gate driver on the second liquid crystal display panel tends to latch-up, thus giving rise to an erroneous operation of the gate driver on the second liquid crystal display panel.

The following techniques (a) to (c) may be considered in an effort to solve the above-mentioned drawbacks.

(a) As the power source line on the first liquid crystal display panel and the connection line on the flexible printed circuit board, a line which exhibits low resistance may be used.

(b) The line widths of the power source line on the first liquid crystal display panel and the connection line on the flexible printed circuit board may be broadened.

(c) Parts, such as capacitances for stabilizing the power source, may be provided on the second liquid crystal display panel.

However, due to restrictions imposed on the line pitch in the manufacture of the flexible printed circuit board and restrictions imposed on the picture frame width of the first liquid crystal display panel, it is difficult to broaden the line widths of the power source line on the first liquid crystal display panel and the connection line on the flexible printed circuit board. Further, the above-mentioned techniques (a) to (c) also constitute factors which tend to increase the cost of manufacture.

The present invention has been made to overcome the above-mentioned drawbacks, and it is an object of the present invention to provide a technique, in an integral-type liquid crystal display module which includes a first liquid crystal display panel and a second liquid crystal display panel, which can decrease the voltage drop attributed to the wiring resistance of a drive voltage supplied to the second liquid crystal display panel without increasing the cost of manufacture.

The above-mentioned and other objects and novel features of the present invention will become apparent from the description provided in this specification and the attached drawings.

### SUMMARY OF THE INVENTION

To achieve the above-mentioned object, the present invention provides a display device which includes a first display panel, a second display panel, and a flexible printed circuit board which connects the first display panel and the second display panel. The first display panel includes a power source circuit which generates a drive voltage. The second display panel includes a scanning line drive circuit which drives scanning lines of the second display panel, a power source line of the first display panel, a power source line to which the drive voltage generated by the power source circuit is supplied through a connection line of the flexible printed circuit board, and a variable resistance circuit which is connected with the power source line. The scanning line drive circuit drives the scanning lines of the second display panel in response to a drive voltage outputted from the variable resistance circuit.

Further, in accordance with the present invention, the variable resistance circuit is provided inside of the scanning line drive means.

Still further, in accordance with the invention, the variable resistance circuit includes a first plurality of transistors which are inserted in the power source line and are connected in series, and a second plurality of transistors which are inserted in the power source line and are connected in parallel with the first plurality of transistors, wherein when the first plurality of transistors which are connected in series are turned on and the second plurality of transistors which are connected in parallel therewith are turned off, the resistance value of the variable resistance circuit assumes a high resistance, and when the second plurality of parallel connected transistors are turned on, the resistance value of the variable resistance circuit assumes a low resistance.

A brief explanation of advantageous effects obtained by representative aspects of the present invention as disclosed in this specification is as follows.

According to the present invention, in the integral-type liquid crystal display module provided with the first display panel and the second display panel, it is possible to reduce fluctuation, attributed to the wiring resistance, of the drive voltage supplied to the second display panel without increasing the cost of manufacture.

### BRIEF DESCRIPTION OF THE DRAWINGS

FIG. 1 is a schematic diagram showing the constitution of a liquid crystal display module representing an embodiment of the present invention;

FIG. 2 is a timing chart showing one example of the operational timing of the second liquid crystal display panel (SUB) shown in FIG. 1;

FIG. 3A-3C are circuit diagrams showing one example of the variable resistance circuit shown in FIG. 1;

FIG. 4 is a circuit diagram showing one example of the scanning line control switch circuit shown in FIG. 1;

FIG. 5 is a circuit diagram showing one example of the sub control circuit shown in FIG. 1;

FIG. 6 is a timing chart showing another example of the operational timing of the second liquid crystal display panel (SUB) shown in FIG. 1;

FIG. 7 is a timing chart showing another example of the operational timing of the second liquid crystal display panel (SUB) shown in FIG. 1;

FIG. 8 is a block diagram showing the constitution of a power source circuit located inside of a liquid crystal driver (DRV) of the liquid crystal display module of the embodiment of the present invention;

FIG. 9 is a circuit diagram showing one example of the 1.5-times/2-times booster circuit shown in FIG. 8;

FIG. 10 is a circuit diagram showing another example of the 1.5-times/2-times booster circuit shown in FIG. 8;

FIG. 11 is a circuit diagram showing still another example of the 1.5-times/2-times booster circuit shown in FIG. 8;

FIG. 12 is a table showing a boosting operational state of each of the 1.5-times/2-times booster circuits shown in FIG. 9 to FIG. 11; and

FIG. 13 is a block diagram showing the constitution of a power source circuit located inside of a liquid crystal driver (DRV) of a conventional liquid is crystal display module.

### DETAILED DESCRIPTION OF THE INVENTION

Hereinafter, various embodiments of the present invention will be explained in detail in conjunction with the attached drawings.

In all of the drawings, parts having identical functions are given the same symbols, and a repeated explanation thereof is omitted.

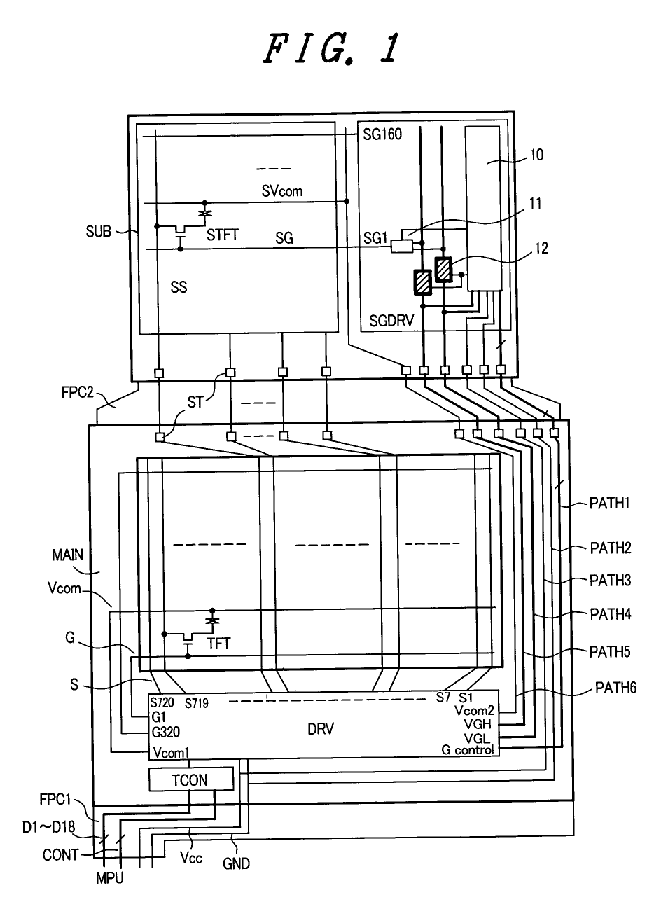

FIG. 1 is a schematic diagram showing the constitution of a liquid crystal display module representing an embodiment of the present invention. The liquid crystal display module of this embodiment is an integral-type liquid crystal display module which includes a first liquid crystal display panel and a second liquid crystal display panel.

In the drawing, the symbol MAIN indicates the first liquid crystal display panel, which constitutes a main display part when a foldable mobile phone is used in an opened state, and symbol SUB indicates a second liquid crystal display panel, which constitutes a sub display part when the foldable mobile phone is used in a closed state.

In this embodiment, the number of sub pixels of the first liquid crystal display panel (MAIN) is set to 240×3(R·G·B)×320, while the number of sub pixels of the second liquid crystal display panel (SUB) is set to 120×3×160.

The first liquid crystal display panel (MAIN) and the second liquid 10 crystal display panel (SUB) are constituted such that a TFT substrate, on which pixel electrodes, thin film transistors and the like are formed, and a filter substrate, on which counter electrodes, color filters and the like are formed are overlapped relative to each other with a given gap therebetween, and both substrates are laminated to each other by use of a sealing material is which is formed in a frame shape in the vicinity of and between peripheral portions of both substrates. Liquid crystal is filled and sealed between both substrates and inside of the sealing material through a liquid crystal filling port formed in a portion of the sealing material, and polarizers are laminated to the outsides of both substrates.

Here, the present invention is not relevant to the inner structure of the liquid crystal display panels, and, hence, detailed explanation of the inner structure of the liquid crystal display panels is omitted. Further, the present invention is applicable to a liquid crystal display panel of any structure.

In this embodiment, on a glass substrate of the first liquid crystal 2 5 display panel (the glass substrate constituting a portion of a TFT substrate of the first liquid crystal display panel), a liquid crystal driver (DVR) and a TFT controller (TCON) are mounted.

First, on a glass substrate of the second liquid crystal display panel, a sub-scanning-line drive circuit (SGDRV), which constitutes scanning line drive means of the present invention, is mounted.

The liquid crystal driver (DVR) includes a video line drive circuit which drives video lines (S1 to S720) of the first liquid crystal display panel(MAIN) and video lines(SS1 to SS360) of the second liquid crystal display panel (SUB), a main scanning line drive circuit which drives scanning lines (G1 to G320) of the first liquid crystal display panel(MAIN), a main lo Vcom drive circuit which drives a common line(Vcom) of the first liquid crystal display panel (MAIN), a sub Vcom drive circuit which drives a common line(SVcom) of second liquid crystal display panel (SUB), a sub-scanning-line-drive-circuit control circuit which controls the sub-scanning-line drive circuit(SGDRV), a memory which stores the display is data, a memory control circuit, a power source circuit and the like. To the TFT controller (TCON), display data (D1 to D18) and a display control signal (CONT) are inputted from a host-side microprocessing unit (hereinafter referred to as a MPU) through a flexible printed circuit board (FPC1).

In FIG. 1, the liquid crystal driver (DRV) and the TFT controller (TCON) are shown in a state in which these parts are respectively constituted of independent semiconductor chips. However, the liquid crystal driver (DRV) and the TFT controller (TCON) may be formed of one semiconductor chip. Further, the sub-scanning-line drive circuit (SGDRV) may be formed of a semiconductor chip.

As shown in FIG. 1, the first liquid crystal display panel (MAIN) and the second liquid crystal display panel (SUB) are connected to a flexible printed circuit board (FPC2) through terminals (ST).

The video lines (SS1 to SS360) of the second liquid crystal display panel (SUB) are connected to the liquid crystal driver (DRV) through the connection lines of the flexible printed circuit board (FPC2) and the video lines (S1 to S360) of the first liquid crystal display panel (MAIN). Further, to the sub-scanning-line drive circuit (SGDRV), sub-scanning-line-driver-circuit control signals are inputted from the liquid crystal driver (DRV) through a power source line (PATH1) of the first liquid crystal display panel (MAIN), the connection lines of the flexible printed circuit board (FPC2) and a power source line of the second liquid crystal display panel (SUB).

Still further, to the sub-scanning-line drive circuit (SGDRV), a first drive voltage (VGL) and a second drive voltage (VGH) are inputted from the liquid crystal driver (DRV) through power source lines (PATH4, PATH5) of the first liquid crystal display panel (MAIN), the connection lines of the flexible printed circuit board (FPC2) and the power source line of the second liquid crystal display panel (SUB).

Here, the first drive voltage (VGL) is a gate non-selection voltage (that is, a voltage which turns off the thin film transistor (STFT)) which is outputted to the scanning lines (SG1 to SG160) of the second liquid crystal display panel (SUB) from the sub-scanning-line drive circuit (SGDRV), while the second drive voltage (VGH) is a gate selection voltage (that is, a voltage which turns on the thin film transistor (STFT)) which has a potential higher than the potential of the first drive voltage (VGL) and is outputted to the scanning lines (SG1 to SG160) of the second liquid crystal display panel (SUB) from the sub-scanning-line drive circuit(SGDRV).

Further, to the sub-scanning-line drive circuit (SGDRV), a power source voltage (Vcc, GND) of the sub-scanning-line drive circuit (SGDRV) is also inputted through power source lines (PATH2, PATH3) of the first liquid crystal display panel (MAIN), the connection lines of the flexible printed circuit board (FPC2) and a power source line of the second liquid crystal display panel (SUB).

Further, the common line (SVcom) of the second liquid crystal display panel (SUB) is connected to the liquid crystal driver (DRV) through the connection lines of the flexible printed circuit board (FPC2) and a power source line (PATH6) of the first liquid crystal display panel (MAIN).

The sub-scanning-line drive circuit(SGDRV) includes a sub control circuit 10, a scanning line control switch circuit 11, and a variable resistance circuit 12, which is inserted in the power source line that supplies the first drive voltage (VGL) and the power source line that supplies the second drive voltage (VGH).

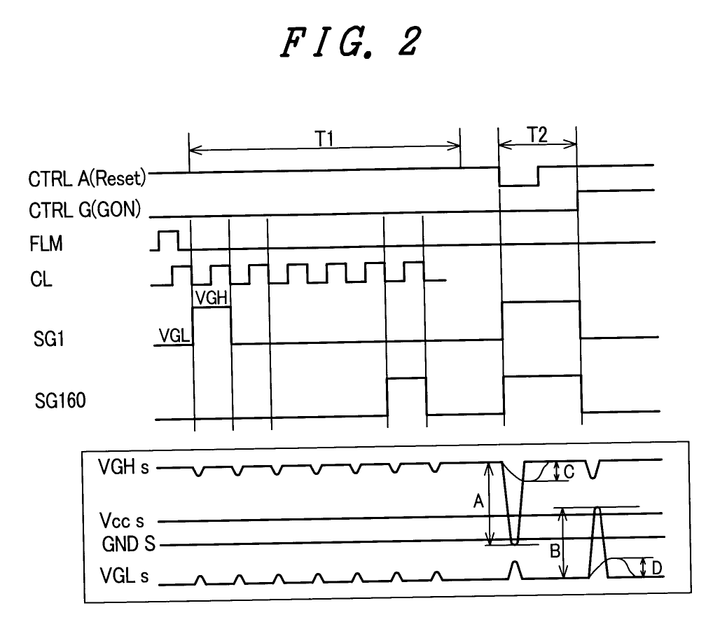

FIG. 2 is a timing chart showing one example of the operational timing of the second liquid crystal display panel (SUB) shown in FIG. 1.

In FIG. 2, the period (T1) indicates a usual display period, and all scanning lines ranging from SG1 to SG160 are sequentially selected during this period (T1). Further, the period (T2) indicates an all scanning line selection period, and all scanning lines ranging from SG1 to SG160 are simultaneously selected during this period (T2). The period (T2) is a period for displaying an all black mode (or an all white mode) on the display part of the second liquid crystal display panel (SUB) when the integral-type liquid crystal display module of this embodiment is turned on or off.

In this period (T2), since an electric current flows in all gates of the thin film transistors (STFT) of the second liquid crystal display panel (SUB), a large electric current flows in the power source line (PATH5) of the first liquid crystal display panel (MAIN) and the connection line of the flexible printed circuit board (FPC2). Assuming that the variable resistance circuit 12 is not present in the sub scanning line drive circuit (SGDRV), due to the wiring resistance of the power source line (PATH5) of the first liquid crystal display panel (MAIN) and of the connection line of the flexible printed circuit board (FPC2), the voltage of the second drive voltage (VGH) will be lowered.

In the same manner, when this period (T2) ends, since the electric current flows out from all gates of the thin film transistors (STFT) of the second liquid crystal display panel (SUB), a large electric current flows in the power source line (PATH4) of the first liquid crystal display panel (MAIN) and the connection line of the flexible printed circuit board (FPC2). Assuming that the variable resistance circuit 12 is not present in the sub scanning line drive circuit (SGDRV), due to the wiring resistance of power source line (PATH4) of the first liquid crystal display panel (MAIN) and the connection line of the flexible printed circuit board (FPC2), the voltage of the first drive voltage (VGL) will be elevated.

When the voltage of the second drive voltage (VGH) is lowered to a level below the power source voltage (Vcc) of the sub scanning line drive circuit (SGDRV), as indicated by symbol A in FIG. 2, or the voltage of the first drive voltage (VGL) is elevated to a level above the power source voltage (GND) of the sub scanning line drive circuit (SGDRV), as indicated by symbol B in FIG. 2, the thin film transistor in the sub scanning line drive circuit (SGDRV) of the second liquid crystal display panel (SUB) is caused to latch-up, thus giving rise to the drawback that the sub scanning line drive circuit (SGDRV) of the second liquid crystal display panel (SUB) causes an erroneous operation.

In this embodiment, the variable resistance circuit 12 is provided in the sub scanning line drive circuit (SGDRV), whereby, during the period (T2) shown in FIG. 2, the resistance value of the variable resistance circuit 12 is increased, thus decreasing the current value of the electric current which flows in all gates of the thin film transistors (STFT) of the second liquid crystal display panel (SUB). Thus, it is possible to prevent a large current from flowing in the power source lines (PATH4, PHTH5) of the first liquid crystal display panel (MAIN) and the connection line of the flexible printed circuit board (FPC2).

Accordingly, in this embodiment, as indicated by the symbols C, D in FIG. 2, the voltage drop of the second drive voltage (VGH), or the voltage elevation of the first drive voltage (VGL), becomes small, and, hence, it is possible to prevent the thin film transistors in the sub scanning line drive circuit (SGDRV) of the second liquid crystal display panel (SUB) from generating a latch-up condition, and, also, it is possible to prevent the sub scanning line drive circuit (SGDRV) of the second liquid crystal display panel (SUB) from generating an erroneous operation.

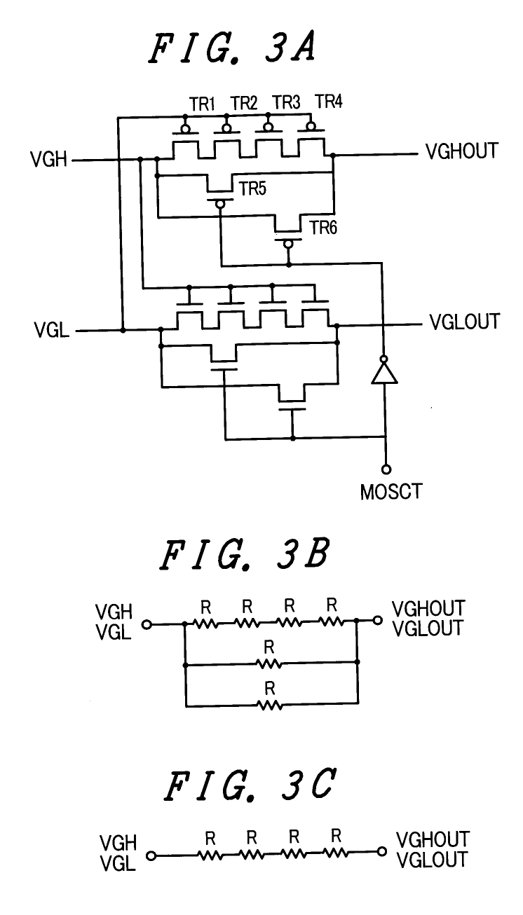

FIG. 3A and FIG. 3B are circuit diagrams showing one example of the variable resistance circuit 12 shown in FIG. 1.

The variable resistance circuit 12 shown in FIG. 3A is constituted of four transistors (TR1 to TR4), which are connected in series to the power source line which supplies the first drive voltage (VGL), or to the power source line which supplies the second drive voltage (VGH), and two transistors (TR5 to TR6), which are connected in parallel to the transistors TR1 to TR4 in the power source line which supplies the first drive voltage (VGL) or the power source line which supplies the second drive voltage (VGH).

In this case, in the variable resistance circuit 12 which is inserted in the power source line which supplies the first drive voltage (VGL), the six transistors are constituted of n-type transistors, while in the variable resistance circuit 12 which is inserted in the power source line which supplies the second drive voltage (VGH), the six transistors are constituted of p-type transistors.

Further, the four transistors (TR1 to TR4) which are connected in series are always turned on, while the two transistors (TR5 to TR6) which are connected in parallel thereto are subjected to an ON/OFF control in response to a MOS control signal (MOSCT).

In the usual mode of operation, the two transistors (TR5 to TR6) which are connected in parallel are turned on, resulting in an equivalent circuit as shown in FIG. 3B. Further, in a high resistance mode, the two parallel connected transistors (TR5 to TR6) are turned off, resulting in and an equivalent circuit as shown in FIG. 3C.

Assuming that the ON resistance of each transistor is R, the resistance value (Ron) of the variable resistance circuit 12 in the usual mode is expressed by the following formula (1). Further, the resistance value (Roff) of the variable resistance circuit 12 in the high resistance mode is expressed by the following formula (2).
1/Ron=¼R+1/R+1/R
Ron=4R/9≈0.45×R (1)
Roff=4R (2)

In this manner, in the circuit shown in FIG. 3A, the resistance value (Roff) of the variable resistance circuit 12 in the high resistance mode is 9 times as high as the resistance value (Ron) of the variable resistance circuit 12 in the usual mode (Roff=9×Ron).

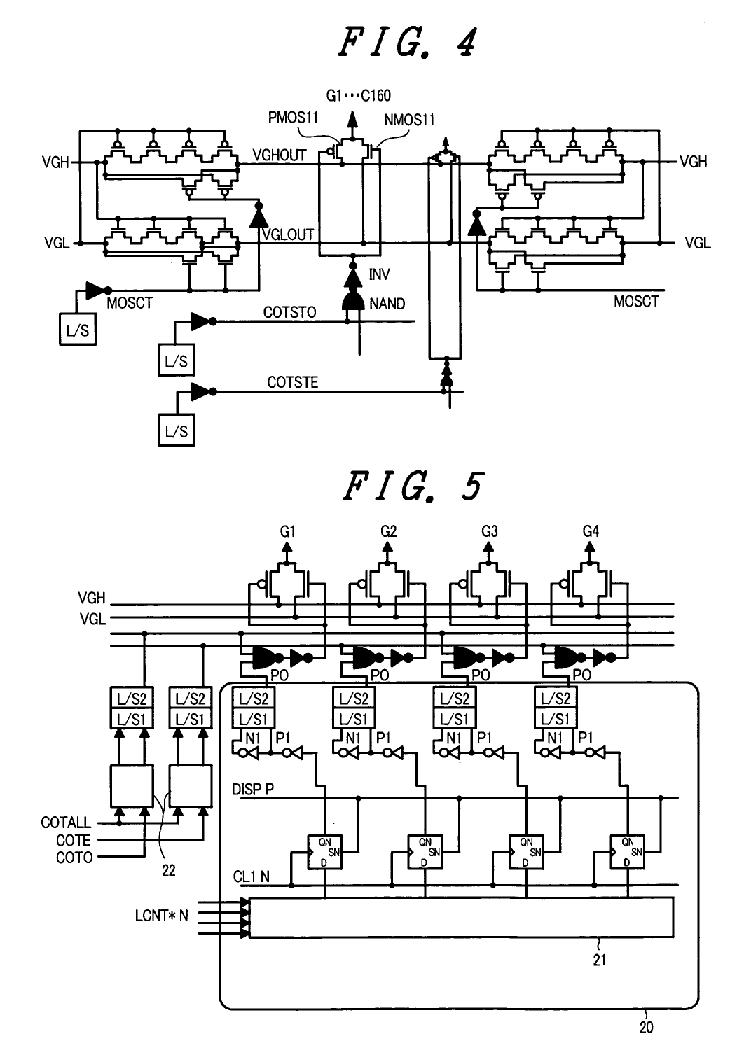

FIG. 4 is a circuit diagram showing one example of the scanning line control switch circuit 11 shown in FIG. 1.

The scanning line control switch circuit 11 is constituted of an n-type transistor (MNOS11), which is connected to the power source line that supplies the first drive voltage (VGL), and a p-type transistor (PMOS11), which is connected to the power source line that supplies the second drive voltage (VGH).

In FIG. 4, for example, during the period (T2) shown in FIG. 2, all scanning lines are not selected simultaneously. That is, the odd-numbered scanning lines and the even-numbered scanning lines are selected in a divided manner. The p-type transistor (PMOS11) and the n-type transistor (NMOS11) are controlled in response to an odd-numbered terminal control signal (COTSTO) or an even-numbered terminal control signal (COTSTE). Here, the odd-numbered terminal control signal (COTSTO) and the even-numbered terminal control signal (COTSTE) are applied to gates of the p-type transistor (PMOS11) and the n-type transistor (NMOS11) through a logic circuit which is formed of a NAND circuit (NAND) and an inverter (INV).

As seen in FIG. 4, the variable resistance circuits 12 are arranged on both sides of these transistors. In such a constitution, by providing the sub scanning line drive circuit (SGDRV) above the second liquid crystal display panel (SUB), it is possible to supply the first drive voltage (VGL) and the second drive voltage (VGH) from both sides. In FIG. 4, symbol L/S indicates a level shift circuit.

FIG. 5 is a circuit diagram showing an example of the sub control circuit 10 shown in FIG. 1.

The sub control circuit 10 includes a counter recorder circuit 21, and the scanning lines ranging from SG1 to SG160 are sequentially selected in the usual mode using the sub control circuit 10.

Further, in the high resistance mode, the operation of the circuit within a frame indicated by numeral 20 in FIG. 5 is stopped, and, at the same time, a collective control signal (COTALL) becomes effective. Based on the collective control signal (COTALL), an odd-numbered terminal signal (COTO) and an even-numbered terminal signal (COTE), the control circuit 22 generates the odd-numbered terminal control signal (COTSTO) and the even-numbered terminal control signal (COTSTE), and these signals are output to the logic circuit constituted of the NAND circuit (NAND) and the inverter (INV). Due to such a constitution, the above-mentioned operations are executed.

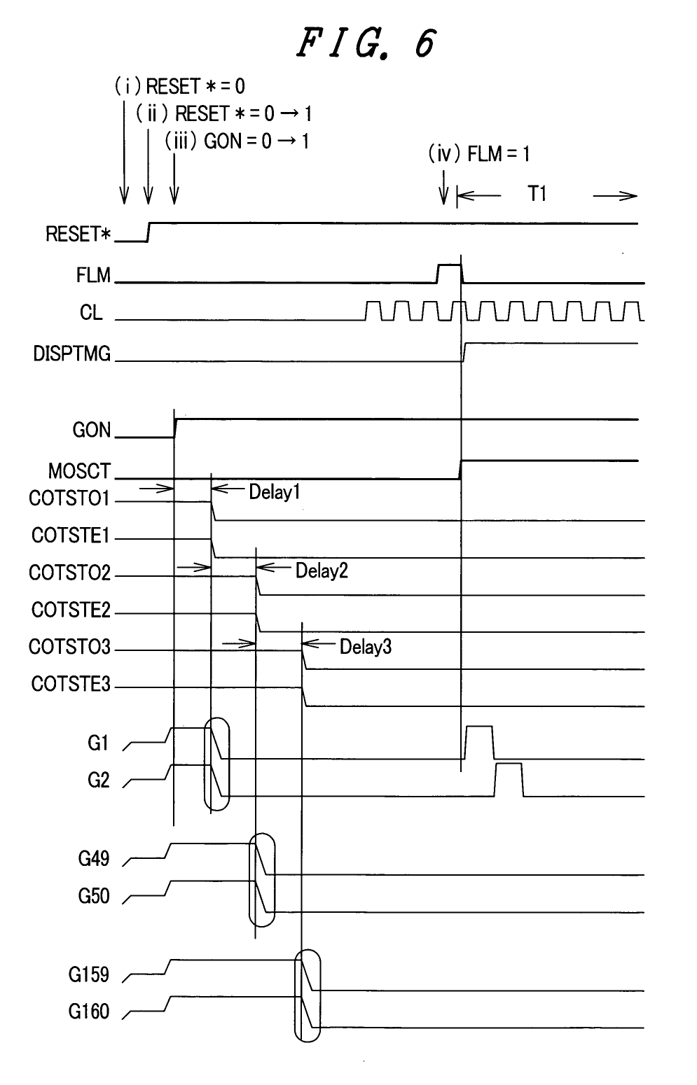

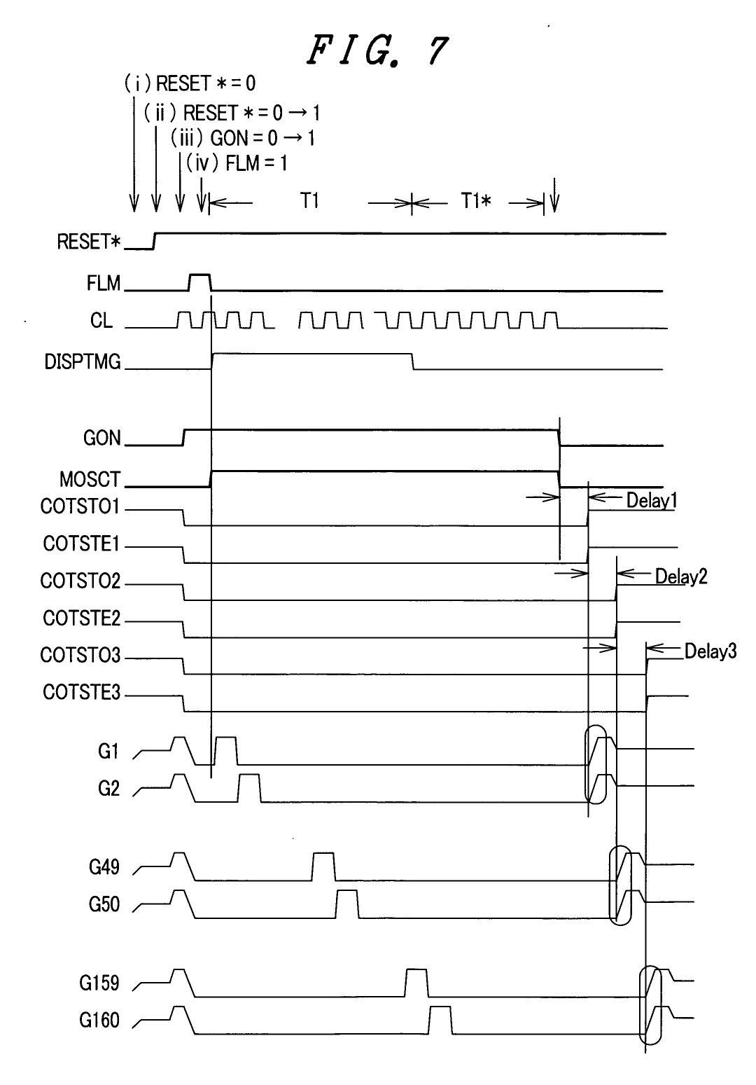

FIG. 6 and FIG. 7 are timing charts showing another example of the operational timing of the second liquid crystal display panel (SUB) shown in FIG. 1.

FIG. 6 shows the operational timing when the integral-type liquid crystal display module of this embodiment is turned on, and FIG. 7 shows the operational timing when the integral-type liquid crystal display module of this embodiment is turned off.

In FIG. 6 and FIG. 7, RESET* indicates a reset signal, symbol FLM indicates a frame start signal, symbol CL indicates a shift clock, symbol DISPTMG indicates a display timing signal, and symbol GON indicates a gate operation setting signal. In FIG. 6 and FIG. 7, when the display timing signal (DISPTMG) and the gate operation setting signal (GON) assume the level “1”, the usual operation is performed.

In accordance with the operational timing shown in FIG. 6, all scanning lines (SG1 to SG160) are at first set to the second drive voltage (VGH), and, thereafter, all scanning lines (SG1 to SG160) are set to the first drive voltage (VGL) so as to start the usual operation. In this case, the odd-numbered terminal control signal (COTSTO) and the even-numbered terminal control signal (COTSTE) are divided into three signals, that is, COTSTO1 to COTSTO3 and COTSTE1 to COTSTE3, respectively; and, at the same time, the scanning lines are also divided into three groups, and the timing which sets the voltage level of the scanning lines to the second drive voltage (VGH)→the first drive voltage (VGL) is executed three times by delaying the timing for every group.

Further, in the operational timing shown in FIG. 7, all scanning lines (SG1 to SG160) are elevated to the second drive voltage (VGH) from the first drive voltage (VGL), and the operation is completed. Here, in FIG. 7, symbol T1* indicates a retrace period. Also, in this case, the timing which sets the voltage level of the scanning lines to the first drive voltage (VGL)→the second drive voltage (VGH) is executed three times by delaying the timing for every group.

In FIG. 6 and FIG. 7, at the timing surrounded by an elongated oval frame, the current peak becomes maximum. However, at the timing shown in FIG. 6 and FIG. 7,the scanning lines are divided into three groups, and the driving is performed by delaying the timing for respective groups at the time of driving all scanning signal lines; and, hence, the amount of an electric current which flows in the lines can be reduced to ⅓ compared to the amount of electric current which flows in the lines when all scanning lines are simultaneously driven.

Accordingly, by adopting the timings shown in FIG. 6 and FIG. 7, it is possible to overcome the drawback that the thin film transistors in the sub scanning line drive circuit (SGDRV) of the second liquid crystal display panel (SUB) cause a latch-up condition and generate erroneous operations of the sub scanning line drive circuit (SGDRV) of the second liquid crystal display panel (SUB).

In the power source circuit arranged inside of the liquid crystal driver (DRV) shown in FIG. 1, an input voltage (VIN) is boosted to generate the following voltages.

(1) Approximately 6.0V to 5.0V (the drive voltage applied to the video lines and the Vcom generating voltage)

(2) Approximately 16.5V to 9V (the voltage which turns on the gates of the thin film transistors (TFT, STFT))

(3) Approximately −5.5V to −4V (the voltage which turns off the gates of the thin film transistors (TFT, STFT))

FIG. 13 shows an example of a conventional power source circuit that is provided when the input voltage (VIN) is 3.0V. In FIG. 13, numeral 31 indicates a regulator and numerals 32, 33, 34 indicate booster circuits.

In FIG. 13, the input voltage (VIN) is regulated to a voltage V1 (3.0V) by the regulator 31, and the voltage V1 is boosted by a two-times booster circuit 32, thus generating and outputting a voltage V2 (6.0V), which is obtained by increasing the voltage V1 two times. The voltage V2 is boosted by a two-times booster circuit 33, thus generating a voltage V3 (12V), which is twice as high as the voltage V2. Further, the voltage V2 is boosted by a (−1)-time booster circuit 34, thus generating a voltage V4 (−6V), which is obtained by boosting the voltage V2 by (−1) times.

Recently, efforts to effect a lowering of the input voltage (VIN) have been making steady progress, and there exists a demand to provide 1.8V with respect to the input voltage (VIN). However, in this case, the voltage V2 cannot be generated with two-times boosting.

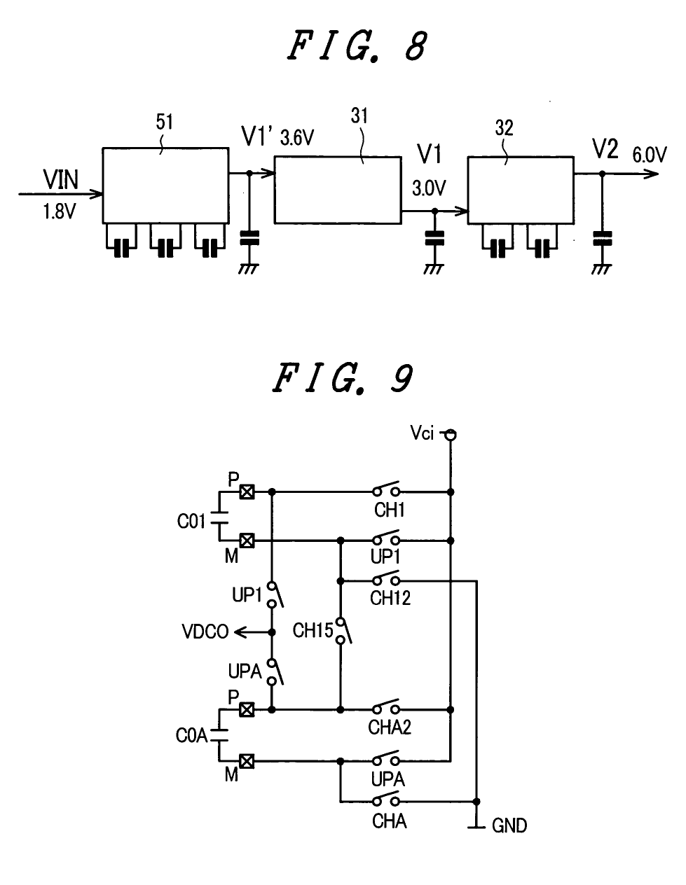

FIG. 8 is a block diagram showing the constitution of a power source circuit provided in the liquid crystal driver (DRV) of the liquid crystal display module of the embodiment of the present invention shown in FIG. 1. In FIG. 8, numeral 31 indicates a regulator and numerals 51, 32 indicate booster circuits. The power source circuit shown in FIG. 8 is constituted such that a booster circuit 51 is added to the power source circuit shown in FIG. 13.

In the power source circuit shown in FIG. 8, the input voltage (VIN) of 1.8V is boosted by a 1.5-times/2-times booster circuit 51, thus forming a voltage V′(3.6V), which is twice as large as the input voltage (VIN). The voltage V1′ is regulated using the regulator 31, and the voltage V1(3V) is generated. Next, the voltage V1 is boosted by the two-times booster circuit 32, thus generating and outputting the voltage V2 (6.0V), which is twice as large as the voltage V1. Based on this voltage V2, the voltages V3, V4 are generated using the two-times booster circuit 33 shown in FIG. 13 or the (−1)-times booster circuit 34.

According to the circuit constitution shown in FIG. 8, it is unnecessary to increase the dielectric strength of the MOS process, and it is possible to use MOS switches which exhibit a low ON resistance. In this manner, according to the power source circuit shown in FIG. 8, even when the input voltage (VIN) is a low voltage, it is possible to generate the voltage V2 without using a high dielectric resistance transistor.

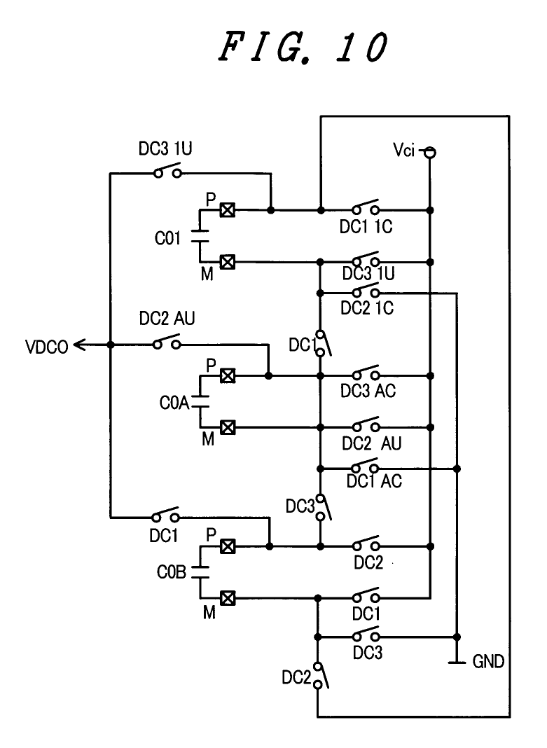

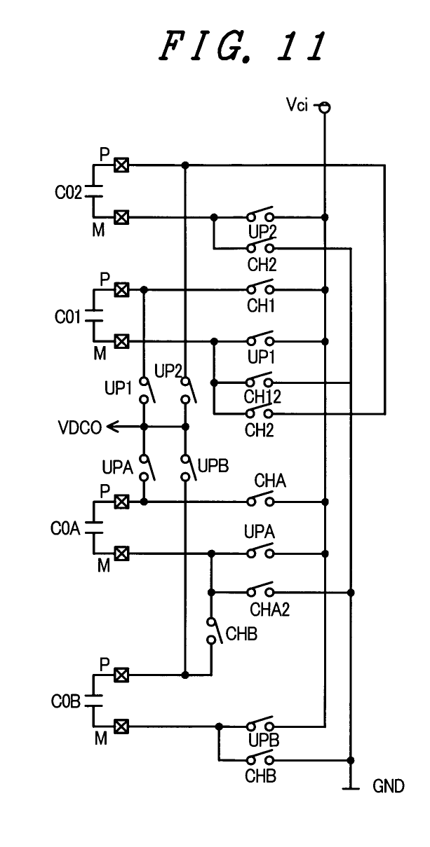

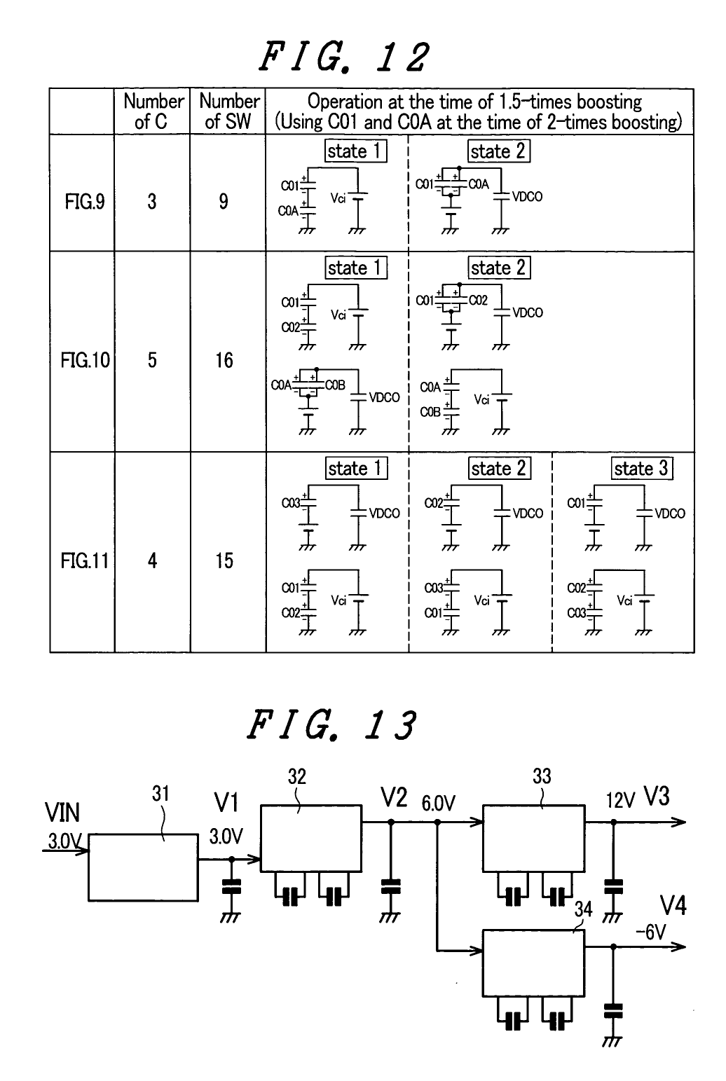

FIG. 9 to FIG. 11 show examples of the 1.5-times/2-times booster circuit 51 shown in FIG. 8, and the state of the boosting operation for each example is shown in FIG. 13.

In the description of the above-mentioned embodiment, an explanation was given with respect to a case in which the thin film transistor (TFT) of the first liquid crystal display panel (MAIN) and the thin film transistor (STFT) of the second liquid crystal display panel (SUB) are formed of a thin film transistor in which a semiconductor layer is made of amorphous silicon. However, at least one of the thin film transistor (TFT) of the first liquid crystal display panel (MAIN) and the thin film transistor (STFT) of the second liquid crystal display panel (SUB) may be formed of a film transistor in which a semiconductor layer is made of polysilicon.

Further, when a thin film transistor, in which the semiconductor layer is made of polysilicon, is used as the film transistor (TFT) of the first liquid crystal display panel (MAIN), it is unnecessary to use a semiconductor chip. That is, in the formation of the liquid crystal driver (DRV) and the TFT controller (TCON), when thin film transistors, in which the semiconductor layer is made of polysilicon, are used, the thin film transistors may be formed integrally with the active elements (TFT) on the first liquid crystal display panel (MAIN).

In the same manner, when a thin film transistor in which the semiconductor layer is made of polysilicon is used as the thin film transistor (STFT) of the second liquid crystal display panel (SUB), it is unnecessary to use a semiconductor chip. That is, thin film transistors in which the semiconductor layer is made of polysilicon may be used as the sub scanning line drive circuit (SGDRV), and these thin film transistors may be formed integrally with the active elements (TFT) on the second liquid crystal display panel (SUB).

Further, in the description of each of the above-mentioned embodiments, an explanation has been given with respect to an integral-type liquid crystal display module which includes a first liquid crystal display panel (MAIN) and a second liquid crystal display panel (SUB). However, with respect to at least one of the first liquid crystal display panel (MAIN) and the second liquid crystal display panel (SUB), it is possible to use an EL display panel which includes organic EL elements or inorganic El elements.

Although the invention made by inventors of the present invention has been specifically explained in conjunction with respective embodiments thereof, the present invention is not limited to these embodiments, and various modifications can be made without departing from the gist of the present invention.

1. A display device comprising:
a first display panel;
a second display panel; and
a flexible printed circuit board which connects the first display panel and the second display panels; wherein
the first display panel includes a power source circuit which generates a drive voltage, and
the second display panel includes a scanning line drive circuit which drives scanning lines of the second display panel, a power source line of the first display panel, a power source line to which the drive voltage generated by the power source circuit is supplied through a connection line of the flexible printed circuit board, and a variable resistance circuit which is connected with the power source line; and wherein
the scanning line drive circuit drives the scanning lines of the second display panel in response to a drive voltage outputted from the variable resistance circuit.

2. A display device according to claim 1, wherein the resistance value of the variable resistance circuit during an all gate selection period in which the scanning line drive circuit drives all scanning lines of the second display panel is larger than the resistance value of the variable resistance circuit in a usual operation.

3. A display device according to claim 2, wherein during the all gate selection period, the scanning line drive circuit divides the scanning lines of the second display panel into a plurality of groups and simultaneously drives the scanning lines of respective divided groups by delaying the drive timing.

4. A display device according to any one of claims 1 to 3, wherein the variable resistance circuit is provided to two sides of the display panel which face each other in an opposed manner.

5. A display device according to any one of claims 1 to 3, wherein the variable resistance circuit is provided in the inside of the scanning line drive circuit.

6. A display device according to any one of claims 1 to 3, wherein the variable resistance circuit includes a plurality of transistors, and the resistance value of the variable resistance circuit is varied by turning on or off some transistors in the plurality of transistors.

7. A display device according to any one of claims 1 to 3, wherein the variable resistance circuit includes:
a plurality of transistors which are inserted in the power source line and are connected in series; and
a plurality of transistors which are inserted in the power source line and are connected in parallel, wherein
when the plurality of transistors which are connected in series are turned on and the plurality of transistors which are connected in parallel are turned off, a resistance value of the variable resistance circuit assumes a high resistance, and when the plurality of transistors which are connected in parallel are turned on, the resistance value of the variable resistance circuit assumes a low resistance.

8. A display device according to any one of claims 1 to 3, wherein the drive voltage assumes a first drive voltage and a second drive voltage which exhibits a potential higher than a potential of the first drive voltage, and the variable resistance circuit is provided for every first drive voltage and second drive voltage.

9. A display device according to any one of claims 1 to 3, wherein the first display panel includes a display drive circuit, and video lines of the second display panel are connected with the display drive circuit through the connection lines of the flexible printed circuit board.

10. A display device according to claim 9, wherein the video lines of the second display panel are connected with the display drive circuit through the connection lines of the first flexible printed circuit board and video lines of the first display panel.

11. A display device according to claim 9, wherein the video lines of the second display panel are connected with the display drive circuit through the connection lines of the flexible printed circuit board and lines of the first display panel.

12. A display device according to any one of claim 1 to claim 3, wherein at least one of the first display panel and the second display panel includes a transistor element whose semiconductor layer is formed of polysilicon.

13. A display device according to any one of claim 1 to claim 3, wherein the scanning line drive circuit of the second display panel includes a transistor element whose semiconductor layer is formed of polysilicon.

14. A display device according to claim 1, wherein the power source circuit includes a booster circuit which generates a second voltage by boosting a first voltage, and the booster circuit includes a first booster circuit which generates a third voltage which falls between the first voltage and the second voltage by boosting the first voltage and a second booster circuit which generates the second voltage by boosting the third voltage.

15. A display device according to claim 14, wherein the first booster circuit is a 1.5-times booster circuit or a 2-times booster circuit and the second booster circuit is a 2-times booster circuit.
